(19) United States
(12) Patent Application Publication
(10) Pub. No.: US 2026/0121910 A1
(43) Pub. Date: Apr. 30, 2026

(54) METHOD AND APPARATUS FOR DETERMINING FAULTY DEVICE, AND NON-VOLATILE READABLE STORAGE MEDIUM AND ELECTRONIC DEVICE

(71) Applicant: SUZHOU METABRAIN INTELLIGENT TECHNOLOGY CO., LTD., Suzhou, Jiangsu (CN)

(72) Inventors: Jianliang TANG, Suzhou, Jiangsu (CN); Peng CHEN, Suzhou, Jiangsu (CN); Fei LU, Suzhou, Jiangsu (CN); Xiuqiang SUN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/470,455

(22) PCT Filed: Sep. 29, 2024
(86) PCT No.: PCT/CN2024/122097

§ 371 Date: Oct. 22, 2025

(30) Foreign Application Priority Data
Dec. 19, 2023 (CN) 202311747507.9

(51) Int. Cl. H04L 41/0677; H04L 45/243; H04L 49/55

(52) U.S. Cl. CPC H04L 41/0677; H04L 49/555; H04L 45/243

(57) ABSTRACT

Provided are a method and apparatus for determining a faulty device, a non-volatile computer readable storage medium, and an electronic device. The method for determining the faulty device includes: acquiring a target device Identifier (ID) of a target faulty device; searching preset link information for link information which comprises the target device ID; when link information that includes the target device ID is found indication information in link information indicates that a first switch is present on the device link, determining whether the target faulty device on the device link is located between the processor and the first switch; and when the target faulty device is not located between the processor and the first switch, determining whether the target faulty device is a device on a switch board according to preset record item information and the target device ID.

### CROSS-REFERENCE TO RELATED APPLICATION

This application is a National Stage Entry under 35 U.S.C. § 371 of PCT International Application No. PCT/CN2024/122097, filed on Sep. 29, 2024, which claims priority to Chinese Patent Application No. 202311747507.9, filed to the China National Intellectual Property Administration on Dec. 19, 2023 and entitled “Method and Apparatus for Determining Faulty Device, Storage Medium, and Electronic Device”, the entire contents of each of which are incorporated herein by reference for all purposes.

### TECHNICAL FIELD

Embodiments of the present disclosure relate to the field of computers, and in particular, to a method and apparatus for determining a faulty device, a non-volatile computer readable storage medium, and an electronic device.

### BACKGROUND

A Basic Input and Output System (BIOS) refers to a set of programs embedded in a Read-Only Memory (ROM) chip on a motherboard of a computer, and stores the most important power-on self-test, hardware initialization, and underlying system service programs of the computer. A Peripheral Component Interconnect Express (PCIE) is a high-speed serial bus technology configured to connect the motherboard of the computer and other devices, such as a graphics card, a network disk, a Non-Volatile Memory Express (NVME) drive, a Graphics Processing Unit (GPU), etc. PCIE devices usually have higher data transmission speeds and bandwidths, and may provide better performance and scalability compared to traditional PCI buses. In a PCIE depth-first algorithm, Secondary Bus (SecBus) is often referred to as a “secondary bus”, configured to identify a number or an Identifier (ID) of a switch in the PCIE bus. Each switch may have a unique SecBus number. Subordinate Bus (SubBus) is often referred to as a “subordinate bus”, configured to identify a number or an ID of a device in the PCIE bus. When a plurality of devices are connected to one switch, each device may have a unique SubBus number. In summary, the SecBus is configured to identify the switch, while the SubBus is configured to identify the device. These two concepts are used in the PCIE depth-first algorithm to determine a hierarchical relationship between various devices and switches on the PCIE bus, so as to achieve data transmission and management. BMC is the abbreviation for Baseboard Management Controller (BMC), which is an independent chip or integrated circuit located on the motherboard of the computer, and is configured to monitor and manage hardware and software of a computer system.

In the related art, fault localization for ordinary models and ordinary PCIE devices can be achieved accurately. However, for Artificial Intelligence (AI) models with switch boards, the localization is often insufficiently accurate. Typically, a fault can be localized only to a silkscreen on the motherboard, or cannot be localized, and cannot be directly localized to a silkscreen on a switch board. For a smart network card with a plurality of virtual network ports, due to the limited storage and processing capabilities of the BMC, when a virtual network card (Bus Device Function (BDF)) of the smart network card fails, it is often impossible to determine which device reports the error. Due to the inability to achieve accurate localization, it is inconvenient for operation and maintenance personnel to quickly repair in some scenarios.

No effective solution has yet been proposed for the technical problem in the related art, wherein accurately determining a faulty device is achievable for PCIE devices, but determining a faulty device for the AI models with the switch boards is insufficiently accurate.

### SUMMARY

Embodiments of the present disclosure provide a method and apparatus for determining a faulty device, a non-volatile computer readable storage medium, and an electronic device, so as to at least solve the problem in the related art, wherein accurately determining a faulty device is achievable for PCIE devices, but determining a faulty device for AI models with switch boards is insufficiently accurate.

According to one embodiment of the present disclosure, a method for determining a faulty device is provided, which includes: acquiring a target device Identifier (ID) of a target faulty device;
searching preset N+M pieces of link information for link information which includes the target device ID, wherein the N+M pieces of link information have a one-to-one correspondence with N+M connection devices; the N+M connection devices include N connection devices on a motherboard and M connection devices on a switch board; each of the M connection devices is connected to one of P switches on the switch board; and the i-th piece of link information among the N+M pieces of link information includes device IDs of a plurality of devices on the i-th device link which is formed from a processor on the motherboard to the i-th connection device of the N+M connection devices, wherein N, M, and P all are positive integers, and i and j are positive integers less than or equal to N+M; in a case where the j-th piece of link information which includes the target device ID is found from the N+M pieces of link information and the j-th piece of indication information in the j-th piece of link information indicates that a first switch is present on the j-th device link which is formed from the processor to the j-th connection device, determining whether the target faulty device on the j-th device link is located between the processor and the first switch, wherein the first switch is one of the P switches; and in a case where the target faulty device is not located between the processor and the first switch, determining whether the target faulty device is a device on the switch board based on preset record item information and the target device ID, wherein the record item information includes a device ID of each of the P switches.

In one exemplary embodiment, after the searching preset N+M pieces of link information for link information which includes the target device ID, the method further includes: in a case where the j-th piece of link information which includes the target device ID is found from the N+M pieces of link information, and the j-th piece of indication information indicates that the first switch is not present on the j-th device link, determining that the target faulty device is a device on the motherboard.

In one exemplary embodiment, after the determining whether the target faulty device on the j-th device link is located between the processor and the first switch, the method further includes: in a case where the target faulty device is located between the processor and the first switch, determining that the target faulty device is a device on the motherboard.

In one exemplary embodiment, the determining whether the target faulty device on the j-th device link is located between the processor and the first switch includes: in a case where, within the j-th piece of link information, the target device ID is located between a device ID of the processor and the device ID of the first switch, determining that the target faulty device on the j-th device link is located between the processor and the first switch.

In one exemplary embodiment, the determining whether the target faulty device is a device on the switch board based on preset record item information and the target device ID includes: searching the record item information for a record item which includes the target device ID, wherein the record item information includes P record items, the k-th record item among the P record items includes the device ID of the k-th switch among the P switches, and k is a positive integer less than or equal to P; and in a case where the p-th record item which includes the target device ID is found within the record item information, determining that the target faulty device is a device on the switch board and the target faulty device is one of the P switches, wherein p is a positive integer less than or equal to P, and the device ID of the p-th switch among the P switches included in the p-th record item is equal to the target device ID.

In one exemplary embodiment, the determining whether the target faulty device is a device on the switch board based on preset record item information and the target device ID includes: determining P bus number ranges based on P Secondary Bus (SecBus) numbers and P Subordinate Bus (SubBus) numbers corresponding to the P switches included in the record item information, wherein the record item information includes P record items, and the k-th record item among the P record items includes a device ID of the k-th switch among the P switches and a SecBus number and a SubBus number of the k-th switch, k is a positive integer less than or equal to P, a minimum value of the k-th bus number range among the P bus number ranges is the SecBus number of the k-th switch, and a maximum value of the k-th bus number range is the SubBus number of the k-th switch; determining whether the target device ID is located within the P bus number ranges; and in a case where it is determined that the target device ID is located within one of the P bus number ranges, determining that the target faulty device is one of the M connection devices on the switch board.

In one exemplary embodiment, after the determining whether the target device ID is located within the P bus number ranges, the method further includes: in a case where it is determined that the target device ID is not located within any one of the P bus number ranges, determining N+M bus number ranges based on N+M SecBus numbers and N+M SubBus numbers corresponding to the N+M connection devices included in the N+M pieces of link information, wherein the i-th piece of link information among the N+M pieces of link information further includes a SecBus number and a SubBus number of a root port where the i-th connection device is located, a minimum value of the i-th bus number range among the N+M bus number ranges is the SecBus number of the root port where the i-th connection device is located, and a maximum value of the i-th bus number range is the SubBus number of the root port where the i-th connection device is located; determining whether the target device ID is located within the N+M bus number ranges; and in a case where it is determined that the target device ID is located within one of the N+M bus number ranges, determining that the target faulty device is a device on the motherboard.

In one exemplary embodiment, after the determining whether the target device ID is located within the N+M bus number ranges, the method further includes: in a case where it is determined that the target device ID is not located within any one of the N+M bus number ranges, displaying first prompt information, wherein the first prompt information is configured to indicate that a position of the target faulty device is undetermined.

In one exemplary embodiment, after the searching preset N+M pieces of link information for link information which includes the target device ID, the method further includes: in a case where the link information which includes the target device ID is not found within the N+M pieces of link information, determining whether the target faulty device is a device on the switch board based on the preset record item information and the target device ID.

In one exemplary embodiment, the determining whether the target faulty device on the j-th device link is located between the processor and the first switch includes: in a case where, within the j-th piece of link information, the target device ID is not located between a device ID of the processor and the device ID of the first switch, determining that the target faulty device on the j-th device link is not located between the processor and the first switch.

In one exemplary embodiment, in a case where it is determined that the target faulty device is a device on the switch board, the method further includes: acquiring an ID of the switch board and displaying second prompt information, wherein the second prompt information includes the ID of the switch board, and the second prompt information is configured to indicate that the target faulty device is a device on the switch board; or acquiring an ID of the switch board, and displaying third prompt information in a case where the target faulty device is one of the M connection devices, wherein the third prompt information includes the ID of the switch board, and the third prompt information is configured to indicate that the target faulty device is one of the M connection devices on the switch board; or acquiring an ID of the switch board, and displaying fourth prompt information in a case where the target faulty device is one of the P switches, wherein the fourth prompt information includes the ID of the switch board, and the fourth prompt information is configured to indicate that the target faulty device is one of the P switches on the switch board.

In one exemplary embodiment, the acquiring an ID of the switch board includes: acquiring the ID of the switch board from the record item information, wherein the record item information includes the ID of the switch board and P record items, and the k-th record item among the P record items includes a device ID of the k-th switch of the P switches.

In one exemplary embodiment, in a case where it is determined that the target faulty device is the device on the motherboard, the method further includes: acquiring an ID of the motherboard and displaying fifth prompt information, wherein the fifth prompt information includes the ID of the motherboard, and the fifth prompt information is configured to indicate that the target faulty device is a device on the motherboard; or acquiring an ID of the motherboard, and displaying sixth prompt information in a case where the target faulty device is one of the N connection devices, wherein the sixth prompt information includes the ID of the motherboard, and the sixth prompt information is configured to indicate that the target faulty device is one of the N connection devices on the motherboard; or acquiring an ID of the motherboard, and displaying seventh prompt information in a case where the target faulty device is a device other than the N connection devices on the motherboard, wherein the seventh prompt information includes the ID of the motherboard, and the seventh prompt information is configured to indicate that the target faulty device is a device other than the N connection devices on the motherboard.

In one exemplary embodiment, the acquiring an ID of the motherboard includes: acquiring the ID of the motherboard from predetermined connection device description information, wherein the connection device description information includes the ID of the motherboard and the N+M pieces of link information.

In one exemplary embodiment, before the searching preset N+M pieces of link information for link information which includes the target device ID, the method further includes: acquiring device IDs of a plurality of devices on each of N+M device links, wherein the N+M device links include device links respectively formed from the processor to each of the N+M connection devices, and the device IDs of the plurality of devices on the i-th device link among the N+M device links include a device ID of the i-th connection device and a device ID of a root port where the i-th connection device is located; acquiring an ID of the motherboard; and acquiring a SecBus number and a SubBus number of a respective root port where each of the N+M connection devices is located.

In one exemplary embodiment, before the searching preset N+M pieces of link information for link information which includes the target device ID, the method further includes: determining whether one of the P switches is present on each of the N+M device links, to obtain N+M pieces of indication information, wherein the i-th indication information among the N+M pieces of indication information is configured to indicate whether one of the P switches is present on the i-th device link.

In one exemplary embodiment, the acquiring device IDs of a plurality of devices on each of N+M device links includes: in a case where the N+M connection devices are not virtual network port devices, acquiring the device IDs of the plurality of devices on each of the N+M device links sent by the N+M connection devices.

In one exemplary embodiment, before the determining whether the target faulty device is a device on the switch board based on preset record item information and the target device ID, the method further includes: acquiring a device ID of each of the P switches; acquiring an ID of the switch board; and acquiring a SecBus number and a SubBus number of each of the P switches.

In one exemplary embodiment, before the determining whether the target faulty device is a device on the switch board based on preset record item information and the target device ID, the method further includes: recording the device ID of each of the P switches, and the SecBus number and the SubBus number of each of the P switches into the P record items in the record item information, wherein the k-th record item of the P record items includes the device ID of the k-th switch among the P switches, and the SecBus number and the SubBus number of the k-th switch, k is a positive integer less than or equal to P.

According to another embodiment of the present disclosure, an apparatus for determining a faulty device is provided, which includes: an acquisition module, configured to acquire a target device Identifier (ID) of a target faulty device; a search module, configured to search preset N+M pieces of link information for link information which includes the target device ID, wherein the N+M pieces of link information have a one-to-one correspondence with N+M connection devices; the N+M connection devices include N connection devices on a motherboard and M connection devices on a switch board; each of the M connection devices is connected to one of P switches on the switch board; and the i-th piece of link information among the N+M pieces of link information includes device IDs of a plurality of devices on the i-th device link which is formed from a processor on the motherboard to the i-th connection device, wherein N, M, and P all are positive integers, and i and j are positive integers less than or equal to N+M; a first determination module, configured to, in a case where the j-th piece of link information which includes the target device ID is found from the N+M pieces of link information and the j-th piece of indication information in the j-th piece of link information indicates that a first switch is present on the j-th device link which is formed from the processor to the j-th connection device, determine whether the target faulty device on the j-th device link is located between the processor and the first switch, wherein the first switch is one of the P switches; and a second determination module, configured to, in a case where the target faulty device is not located between the processor and the first switch, determine whether the target faulty device is a device on the switch board based on preset record item information and the target device ID, wherein the record item information includes a device ID of each of the P switches.

According to still another embodiment of the present disclosure, a non-volatile computer readable storage medium is further provided, in which a computer program is stored. The computer program is configured to perform the steps in any one of the above method embodiments when executed.

According to still another embodiments of the present disclosure, an electronic device is further provided, which includes a memory and a processor. A computer program is stored in the memory, and the processor is configured to execute the computer program to perform the steps in any one of the above method embodiments.

Through the present disclosure, the N+M pieces of preset link information are searched for the link information which includes the target device ID of the target faulty device, where each piece of link information corresponds to one connection device; the connection devices include the N connection devices on the motherboard and the M connection devices on the switch board; each of the M connection devices is connected to one of the P switches on the switch board; and the link information includes the device IDs of the plurality of devices on the device link which is formed from the processor on the motherboard to the connection device; in a case where the j-th piece of link information which includes the target device ID is found and the indication information included in the link information indicates that the first switch is present on the device link, it is determined whether the target faulty device on the device link is located between the processor and the first switch; and in a case where the target faulty device is not located between the processor and the first switch, it is determined whether the target faulty device is a device on the switch board based on the preset record item information and the target device ID, where the record item information includes the device ID of each of the switches. By adopting the above solution, the position of the faulty device can be accurately located, so that the faulty device can be repaired as soon as possible, the time spent on troubleshooting can be reduced, and the user experience can be improved, thereby solving the technical problem in the related art that accurately determining a faulty device for ordinary PCIE devices can be achieved, but determining a faulty device for AI models with switch boards is insufficiently accurate.

### BRIEF DESCRIPTION OF THE DRAWINGS

FIG. 1 is a block diagram of a hardware structure of a BIOS of a method for determining a faulty device according to an embodiment of the present disclosure.

FIG. 2 is a flowchart of a method for determining a faulty device according to an embodiment of the present disclosure.

FIG. 3 is a structural block diagram of an optional system for determining a faulty PCIE device according to an embodiment of the present disclosure.

FIG. 4 is a flowchart of a method for determining a faulty PCIE device according to an embodiment of the present disclosure.

FIG. 5 is schematic diagram of a system architecture of an optional system for determining a faulty device according to an embodiment of the present disclosure.

FIG. 6 is a structural block diagram of an apparatus for determining a faulty device according to an embodiment of the present disclosure.

### DETAILED DESCRIPTION OF THE EMBODIMENTS

Embodiments of the present disclosure are described below with reference to the drawings and in conjunction with the embodiments in detail.

It is to be noted that the terms “first”, “second” and the like in the specification, claims and the above drawings of the present disclosure are used for distinguishing similar objects rather than describing a specific sequence or a precedence order.

The terms in the present disclosure are explained below.

BIOS refers to a basic input and output system.

BMC refers to a baseboard management controller.

Operating System (OS) refers to an operating system.

RpSecBus refers to the Secondary Bus (SecBus) number of a root port of a Central Processing Unit (CPU).

RpSubBus refers to the Subordinate Bus (SubBus) number of the root port of the CPU.

SwitchSecBus refers to the Secondary Bus (SecBus) number of a switch port.

SwitchSubBus refers to the Subordinate Bus (SubBus) number of the switch port.

End Point Device (Ep) refers to a device such as a GPU, a network card, an NVME drive, etc.

It is to be noted that the Ep refers to all PCIE devices in the present disclosure.

An AI model PCIE link refers to CPU Rp→Bridge1→Bridge2→Bridge3→Switch Bridge→Ep.

A direct-attached smart network card link refers to CPU Rp→smart network card.

A switch board refers to an Input/Output (I/O) expansion board with four switch bridge chips, configured to expand an interface of the PCIE device.

SlotId refers to a slot number.

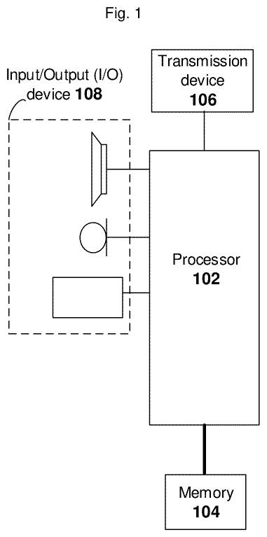

The method embodiment provided by the embodiments of the present disclosure may be performed in a BIOS or a similar computing apparatus. Taking operation on the BIOS as an example, FIG. 1 is a block diagram of a hardware structure of a method for determining a faulty device according to an embodiment of the present disclosure. As shown in FIG. 1, the BIOS may include one or more (only one is shown in FIG. 1) processors 102 (the processors 102 may include, but are not limited to, a Micro Controller Unit (MCU) or a Field Programmable Gate Array (FPGA), and other processing apparatuses), and a memory 104 configured to store data. The above BIOD may further include a transmission device 106 configured for communication functions and an I/O device 108. Those of ordinary skill in the art may understand that the structure shown in FIG. 1 is only schematic and not intended to limit the structure of the above BIOS. For example, the BIOS may further include more or fewer components than those shown in FIG. 1, or have a different configuration from that shown in FIG. 1.

The memory 104 may be configured to store a computer program, for example, a software program or a module of application software, such as a computer program corresponding to a method for determining a faulty device in the embodiments of the present disclosure. The processor 102 executes the computer program stored in the memory 104 to perform various functional applications and data processing, that is, to implement the above method. The memory 104 may include a high speed Random Access Memory (RAM) and may further include a non-volatile memory such as one or more magnetic storage apparatuses, a flash, or other non-volatile solid state memories. In some examples, the memory 104 may further include memories remotely located relative to the processor 102, which may be connected to the BIOS over a network. Examples of the above network include, but are not limited to, the Internet, the Intranet, a local area network, a mobile communication network, and a combination thereof.

The transmission module 106 is configured to receive or transmit data through a network. The above examples of the network may include a wireless network provided by a communication vendor of the BIOS. In one example, the transmission device 106 includes a Network Interface Controller (NIC) that may be connected to other network devices through a base station to communicate with the Internet. In one example, the transmission device 106 may be a Radio Frequency (RF) module, which is configured to communicate with the Internet in a wireless manner.

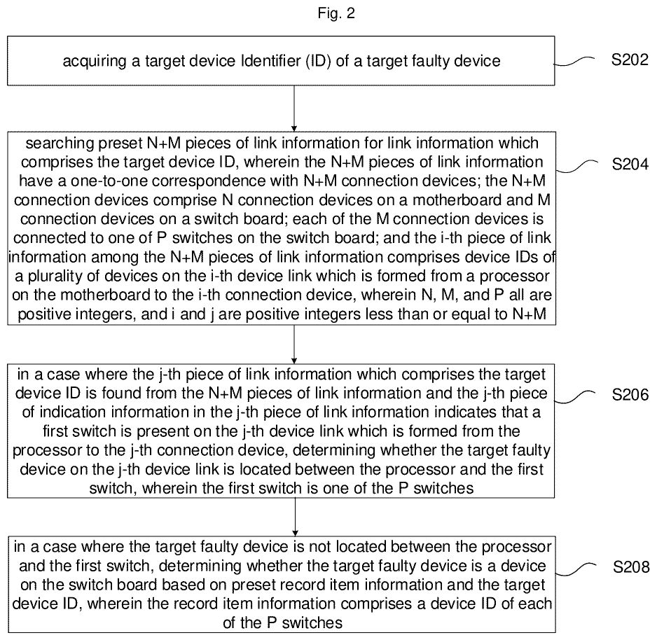

In the present embodiment, a method for determining a faulty device is provided. FIG. 2 is a flowchart of a method for determining a faulty device according to an embodiment of the present disclosure. As shown in FIG. 2, the flow includes the following steps.

At S202, acquiring a target device Identifier (ID) of a target faulty device.

At S204, searching preset N+M pieces of link information for link information that includes the target device ID, wherein the N+M pieces of link information have a one-to-one correspondence with N+M connection devices; the N+M connection devices comprise N connection devices on a motherboard and M connection devices on a switch board; each of the M connection devices is connected to one of P switches on the switch board; and the i-th piece of link information among the N+M pieces of link information comprises device IDs of a plurality of devices on the i-th device link which is formed from a processor on the motherboard to the i-th connection device, wherein N, M, and P all are positive integers, and i and j are positive integers less than or equal to N+M.

At S206, in a case where the j-th piece of link information which comprises the target device ID is found from the N+M pieces of link information and the j-th piece of indication information in the j-th piece of link information indicates that a first switch is present on the j-th device link which is formed from the processor to the j-th connection device, determining whether the target faulty device on the j-th device link is located between the processor and the first switch, wherein the first switch is one of the P switches.

At S208, in a case where the target faulty device is not located between the processor and the first switch, determining whether the target faulty device is a device on the switch board based on preset record item information and the target device ID, wherein the record item information comprises a device ID of each of the P switches.

Through the above steps, the N+M pieces of preset link information is searched for the link information which includes the target device ID of the target faulty device, where each piece of link information corresponds to one connection device; the connection devices include the N connection devices on the motherboard and the M connection devices on the switch board; each of the M connection devices is connected to one of the P switches on the switch board; and the link information includes the device IDs of the plurality of devices on the device link which is formed from the processor on the motherboard to the connection device; in a case where the j-th piece of link information which includes the target device ID is found and the indication information included in the link information indicates that the first switch is present on the device link, it is determined whether the target faulty device on the device link is located between the processor and the first switch; and in a case where the target faulty device is not located between the processor and the first switch, it is determined whether the target faulty device is a device on the switch board based on the preset record item information and the target device ID, where the record item information includes the device ID of each of the switches. By adopting the above solution, the position of the faulty device can be accurately located, so that the faulty device can be repaired as soon as possible, the time spent on troubleshooting can be reduced, and the user experience can be improved, thereby solving the technical problem in the related art that accurately determining a faulty device for ordinary PCIE devices can be achieved, but determining a faulty device for AI models with switch boards is insufficiently accurate.

The execution subject of the above steps may be a BIOS, a computer terminal, etc., but is not limited thereto.

The execution order of S202 and S204 is interchangeable. That is, S204 may be performed first, followed by S202.

In one exemplary embodiment, after the above S204: after the searching preset N+M pieces of link information for link information which includes the target device ID, the method further includes: in a case where the j-th piece of link information which includes the target device ID is found from the N+M pieces of link information, and the j-th piece of indication information indicates that the first switch is not present on the j-th device link, determining that the target faulty device is a device on the motherboard.

In some embodiments, in a case where the link information which includes the target device ID is matched among the N+M pieces of preset link information, and it is determined that no switch bridge (i.e., the first switch) is present in the device link corresponding to the link information according to the indication information included in the link information, it is determined that the target faulty device is a device on the motherboard.

Through the present embodiment, after the link where the target device ID is located is matched, it is further confirmed whether the switch bridge is present on the link, so as to avoid misjudgment and improve the accuracy of localization of the faulty device.

Based on the above steps, after the above S206 of determining whether the target faulty device on the j-th device link is located between the processor and the first switch is performed, the method further includes: in a case where the target faulty device is located between the processor and the first switch, determining that the target faulty device is a device on the motherboard.
in a case where it is determined that the target faulty device is between the processor and the first switch, it is determined that the faulty device is on an uplink of the switch bridge, then it is determined that the faulty device is a device on the motherboard, and the matching process is terminated.

In some embodiments, the above step of determining whether the target faulty device on the j-th device link is located between the processor and the first switch may be implemented by the following solution: in a case where the target device ID in the j-th piece of link information is located between a device ID of the processor and the device ID of the first switch, determining that the target faulty device on the j-th device link is located between the processor and the first switch.

Each piece of link information contains the device IDs of the plurality of devices between the processor and the connection device, and the storage order of the device IDs is configured to represent the order of different devices in the link. Therefore, it is determined whether the target faulty device is located on the uplink of the switch bridge by determining whether the target device ID is located between the device ID of the processor and the device ID of the first switch.

Through the present embodiment, after it is determined that the switch bridge is present in the link, it is further determined whether the faulty device is a device on the motherboard by determining whether the faulty device is located on the uplink of the switch bridge, thereby accurately locating the position of the faulty device.

In some embodiments, the above S208 of determining whether the target faulty device is a device on the switch board based on preset record item information and the target device ID may be implemented by the following solution: searching the record item information for a record item which includes the target device ID, where the record item information includes P record items, the k-th record item among the P record items includes the device ID of the k-th switch among the P switches, where k is a positive integer less than or equal to P; and in a case where the p-th record item which includes the target device ID is found within the record item information, determining that the target faulty device is a device on the switch board and the target faulty device is one of the P switches, where p is a positive integer less than or equal to P, and the device ID of the p-th switch among the P switches included in the p-th record item is equal to the target device ID.

The process of determining whether the target faulty device is a device on the switch board includes: searching the record item information (a PCIE switch asset information table corresponding to a switch linked list) for the record item which includes the target device ID, where each record item in the record item information contains the device ID of the switch (switch bridge); and in a case where the record item which contains the ID of the target device is found, it is determined that the target faulty device is a device on the switch board, and the category of the target faulty device is a switch bridge.

According to the present embodiment, on the basis of matching the faulty link, a BDF (device ID) of the switch bridge is further matched in the PCIE switch asset information table, thereby accurately locating the position of the target faulty device.

In some embodiments, the above S208 of determining whether the target faulty device is a device on the switch board based on preset record item information and the target device ID may be implemented by the following solution: determining P bus number ranges based on P SecBus numbers and P SubBus numbers corresponding to the P switches included in the record item information, where the record item information includes the P record items, and the k-th record item among the P record items includes the device ID of the k-th switch among the P switches and the SecBus number and the SubBus number of the k-th switch, where k is a positive integer less than or equal to P, a minimum value of the k-th bus number range among the P bus number ranges is the SecBus number of the k-th switch, and a maximum value of the k-th bus number range is the SubBus number of the k-th switch; determining whether the target device ID is located within the P bus number ranges; and in a case where it is determined that the target device ID is located within one of the P bus number ranges, determining that the target faulty device is a connection device among the M connection devices on the switch board.

Each record item in the record item information further includes the SecBus number (SwitchSecBus) and the SubBus number (SwitchSubBus) corresponding to the switch, thereby determining the P bus number ranges corresponding to the P switches, where the bus number range is [SwitchSecBus, SwitchSubBus]. It is determined whether the target device ID is located within any one of the P bus ranges, that is, (SwitchSecBus<=BDF<=SwitchSubBus), and in a case where the matching is successful (namely, it is determined that the target device ID is located within one of the P bus number ranges), it is determined that the target faulty device is one of the M connection devices on the switch board.

Based on the above steps, after it is determined whether the target device ID is located within the P bus number ranges, the method further includes: in a case where it is determined that the target device ID is not located within any one of the P bus number ranges, determining N+M bus number ranges based on N+M SecBus numbers and N+M SubBus numbers corresponding to the N+M connection devices included in the N+M pieces of link information, where the i-th piece of link information among the N+M pieces of link information further includes a SecBus number and a SubBus number of a root port where the i-th connection device is located, where a minimum value of the i-th bus number range among the N+M bus number ranges is the SecBus number of the root port where the i-th connection device is located, and a maximum value of the i-th bus number range is the SubBus number of the root port where the i-th connection device is located; determining whether the target device ID is located within the N+M bus number ranges; and in a case where it is determined that the target device ID is located within one of the N+M bus number ranges, determining that the target faulty device is a device on the motherboard.
in a case where the target device ID is not located within any one of the P bus number ranges, it is necessary to continue to traverse the PCIE asset information table which includes the N+M pieces of link information. The link information further includes the SecBus number (i.e., RpSecBus) and the SubBus number (i.e., RpSubBus) of the root port (Rootport) where the connection device is located. The N+M bus number ranges ([RpSecBus, RpSubBus]) are determined, and then it is determined whether the target device ID is located within any one of the N+M bus number ranges. in a case where the matching is successful (that is, RpSecBus<=BDF<=RpSubBus, namely, it is determined that the target device ID is located within one of the N+M bus number ranges), it is determined that the target faulty device is a device on the motherboard.

Based on the above steps, after it is determined whether the target device ID is located within the N+M bus number ranges, the method further includes: in a case where it is determined that the target device ID is not located within any one of the N+M bus number ranges, displaying first prompt information, where the first prompt information is configured to indicate that the position of the target faulty device is undetermined.

After the above matching process, in a case where it is determined that the target device ID is not located within any one of the N+M bus number ranges, it indicates that the matching fails, and at this time, the first prompt information is displayed to a user to inform the user that the position of the target faulty device cannot be determined, and the matching process is terminated.

Based on the above steps, after the N+M pieces of preset link information is searched for the link information which includes the target device ID, the method further includes: in a case where link information which includes the target device ID is not found within the N+M pieces of link information, determining whether the target faulty device is a device on the switch board based on the preset record item information and the target device ID.
in a case where a BDF (target device ID) to be queried does not match the link information which includes the target device ID in the PCIE asset information table, that is, the BDF to be queried does not match a BDF of an Ep, BDFs of upper four-level devices of the Ep, and a RootPort BDF where the Ep is located, and the matching of the PCIE switch asset information (i.e., the above preset record item information) is also continued. The PCIE asset information table is configured to store the above N+M pieces of preset link information.

In some embodiments, the operation of determining whether the target faulty device on the j-th device link is located between the processor and the first switch includes: in a case where, within the j-th piece of link information, the target device ID is not located between the device ID of the processor and the device ID of the first switch, determining that the target faulty device on the j-th device link is not located between the processor and the first switch.
in a case where it is determined in the j-th piece of link information that the position of the target device ID is not between the device ID of the processor and the device ID of the first switch, it is determined that the target faulty device is not located between the processor and the first switch, that is, the faulty device is not on the uplink of the switch bridge.

In some embodiments, in a case where it is determined that the target faulty device is a device on the switch board, the method further includes: acquiring an ID of the switch board and displaying second prompt information, where the second prompt information includes the ID of the switch board, and the second prompt information is configured to indicate that the target faulty device is a device on the switch board; or acquiring an ID of the switch board and displaying third prompt information in a case where the target faulty device is one of the M connection devices, where the third prompt information includes the ID of the switch board, and the third prompt information is configured to indicate that the target faulty device is one of the M connection devices on the switch board; or acquiring an ID of the switch board and displaying fourth prompt information in a case where the target faulty device is one of the P switches, where the fourth prompt information includes the ID of the switch board, and the fourth prompt information is configured to indicate that the target faulty device is one of the P switches on the switch board.

After it is determined that the target faulty device is a device on the switch board, different prompt information is displayed to the user according to the category of the target faulty device, where the category of the target faulty device located on the switch board includes: one (i.e., the PCIE device) of the M connection devices on the switch board, one (i.e., the switch bridge) of the P switches, and other devices on the link. in a case where it is determined that the category of the target faulty device is another device on the link, the ID of the switch board (i.e., silkscreen information of the switch board) is displayed to the user, and the user is informed that the target faulty device is another device on the link. in a case where it is determined that the category of the target faulty device is one of the M connection devices on the switch board, the ID of the switch board is displayed to the user, and the user is informed that the target faulty device is one of the M connection devices. in a case where it is determined that the category of the target faulty device is one of the P switches, the ID of the switch board is displayed to the user, and the user is informed that the category of the target faulty device is one of the P switch boards.

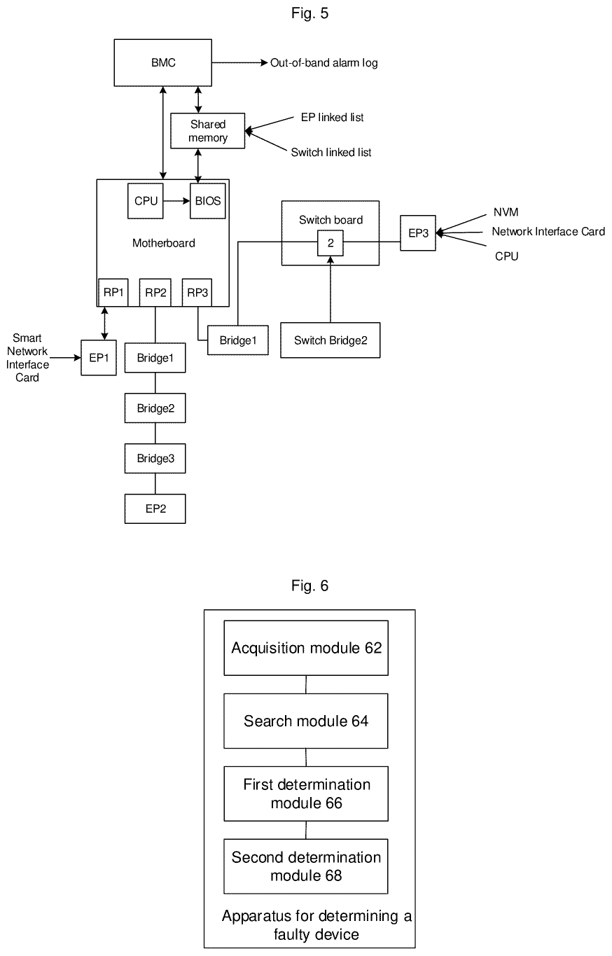

In one optional embodiment, after the target faulty device is located as a device on the switch board and the silkscreen information of the switch board and the category information of the target faulty device are displayed to the user, the target faulty device may further be displayed to the user, that is, the BDF information of the target faulty device is directly displayed to the user, and/or the device ID information of the target faulty device is matched according to the BDF information and displayed to the user, as shown in FIG. 5, to help the user to confirm the target faulty device on the switch board.

Through the present embodiment, while determining the silkscreen information of the switch board, the category of the faulty device is clarified, so that the user can accurately determine the repair strategy and locate the faulty device according to the information, thereby improving the user experience.

In some embodiments, the operation of acquiring an ID of the switch board includes: acquiring the ID of the switch board from the record item information, where the record item information includes the ID of the switch board and the P record items, and the k-th record item among the P record items includes a device ID of the k-th switch of the P switches.

The ID of the switch (i.e., the silkscreen information of the switch board) may be queried in the record item information. The record item information is the PCIE switch asset information generated based on the switch linked list, in which the BDF of each switch bridge and the silkscreen information of the switch board are stored.

In some embodiments, in a case where it is determined that the target faulty device is a device on the motherboard, the method further includes: acquiring an ID of the motherboard and displaying fifth prompt information, where the fifth prompt information includes the ID of the motherboard, and the fifth prompt information is configured to indicate that the target faulty device is a device on the motherboard; or acquiring an ID of the motherboard and displaying sixth prompt information in a case where the target faulty device is one of the N connection devices, where the sixth prompt information includes the ID of the motherboard, and the sixth prompt information is configured to indicate that the target faulty device is one of the N connection devices on the motherboard; or acquiring an ID of the motherboard and displaying seventh prompt information in a case where the target faulty device is a device other than the N connection devices on the motherboard, where the seventh prompt information includes the ID of the motherboard, and the seventh prompt information is configured to indicate that the target faulty device is a device other than the N connection devices on the motherboard.
in a case where it is determined that the target faulty device is a device on the motherboard, it is necessary to acquire the silkscreen information of the corresponding motherboard (i.e., the ID of the above motherboard), and display different prompt information to the user according to the category of the target faulty device, where the categories of the target faulty device located on the motherboard include: one of the N connection devices on the motherboard, a device on the motherboard, and a device other than the N connection devices on the motherboard. in a case where the category of the target faulty device is a device on the motherboard, the silkscreen information of the motherboard is displayed to the user, and the user is informed that the target faulty device is a device on the motherboard. Alternatively, in a case where it is determined that the target faulty device is one of the N connection devices, the screen information of the motherboard is displayed to the user, and the user is informed that the target faulty device is one of the N connection devices. Alternatively, in a case where it is determined that the target faulty device is a device other than the N connection devices on the motherboard, the silkscreen information of the motherboard is displayed to the user, and the user is informed that the target faulty device is a device other than the N connection devices on the motherboard.

In one optional embodiment, after the target faulty device is located as a device on the motherboard and the silkscreen information of the motherboard and the category information of the target faulty device are displayed to the user, the target faulty device may further be displayed to the user, that is, the BDF information of the target faulty device is directly displayed to the user, and/or the device ID information of the target faulty device is matched according to the BDF information and displayed to the user, as shown in FIG. 5, to help the user to confirm the target faulty device on the motherboard.

Through the present embodiment, on the basis of determining that the target faulty device is a device on the motherboard, the category of the target faulty device is further determined, thereby helping the user to more accurately perform fault repair according to the category and position of the faulty device.

In some embodiments, the operation of acquiring an ID of the motherboard includes: acquiring the ID of the motherboard from predetermined connection device description information, where the connection device description information includes the ID of the motherboard and the N+M pieces of link information.

The silkscreen information of the motherboard may be found from the predetermined connection device description information, i.e., the PCIE asset information table, in which the ID of the motherboard (i.e., the silkscreen information of the motherboard) and the N+M pieces of link information are stored.

In one exemplary embodiment, before the N+M pieces of preset link information is searched for the link information which includes the target device ID, the method further includes: acquiring device IDs of a plurality of devices on each of N+M device links, where the N+M device links include a device link which is formed from the processor to each of the N+M connection devices, and the device IDs of the plurality of devices on the i-th device link among the N+M device links include a device ID of the i-th connection device and a device ID of the root port where the i-th connection device is located; acquiring the ID of the motherboard; and acquiring a SecBus number and a SubBus number of a respective root port where each of the N+M connection devices is located.

Before starting fault detection, an Ep linked list (i.e., the above connection device description information) needs to be constructed. The Ep linked list contains the device IDs of the plurality of devices on each of the N+M device links, and each device link contains the plurality of devices between the processor and the connection device, including the connection device and the upper four-level devices of the connection device. In addition, the BDF of RootPort where the connection devices are located and the silkscreen information of the motherboard need to be acquired, and RpSecBus (SecBus number) and RpSubBus (SubBus number) of the root port where each connection device is located are acquired.

In some embodiments, before the N+M pieces of preset link information is searched for the link information which includes the target device ID, the method further includes: determining whether one of the P switches is present on each of the N+M device links, to obtain N+M pieces of indication information, where the i-th indication information among the N+M pieces of indication information is configured to indicate whether one of the P switches is present on the i-th device link.

During the traversal and generation of the Ep linked list, whether the switch bridge (i.e., the switch) is present in the link between the Rp (root port) and the Ep is further scanned, and a scan result (indication information) is further added to the Ep linked list. The indication information is configured to indicate whether a switch is present on the device link.

In some embodiments, the operation of acquiring device IDs of a plurality of devices on each of N+M device links includes: in a case where the N+M connection devices are not virtual network port devices, acquiring the device IDs of the plurality of devices on each of the N+M device links sent by the N+M connection devices.

During the traversal, it is determined whether the connection device is connected to the smart network card according to DeviceId and VendorId of the connection device. in a case where the smart network card is connected, the reporting of the virtual network port device inside the network card may be filtered out, that is, in a case where the connection device is not a virtual network port device, the device IDs of the plurality of devices on the corresponding device link may be acquired.

Through the present embodiment, by filtering out the reporting of the virtual network card device, the storage resources of the BMC may be saved and the capability of the BMC to accurately locate the fault of the smart network card may be improved.

In some embodiments, before it is determined whether the target faulty device is a device on the switch board based on the preset record item information and the target device ID, the method further includes: acquiring the device ID of each of the P switches; acquiring the ID of the switch board; and acquiring the SecBus number and the SubBus number of each of the P switches.

The module continues to traverse all bridges, identifies the switch bridges on the switch board, sequentially parses information for each valid switch bridge, and acquires the corresponding BDF of the switch (device ID of the switch), SwitchSecBus (SecBus number), SwitchSubBus (SubBus number), and the silkscreen information of the switch board (ID of the switch board).

In some embodiments, before it is determined whether the target faulty device is a device on the switch board based on the preset record item information and the target device ID, the method further includes: recording the device ID of each of the P switches and the SecBus number and the SubBus number of each of the P switches into the P record items in the record item information, where the k-th record item among the P record items includes the device ID of the k-th switch among the P switches and the SecBus number and the SubBus number of the k-th switch, where k is a positive integer less than or equal to P.

After the above information is acquired, the switch linked list, i.e., the above record item information, may be generated according to the above information, and the record item information includes the device ID of each of the P switches and the SecBus number and the SubBus number of each switch.

The present disclosure, through the collaborative coding of the BIOS and the BMC, covers determining a faulty device for the PCIE devices of the AI models with the switch boards and determining a faulty device for the plurality of virtual network ports on the smart network cards, so as to reduce the storage space required by the BMC for the PCIE asset information table, improve the search efficiency, improve the operation and maintenance efficiency of AI data centers, and avoid errors caused by manually collecting related error information when automatic fault localization fails, thereby providing significant convenience for operation and maintenance, i.e., achieving a highly significant effect in application scenarios requiring accurate fault diagnosis and localization. At the same time, a code has strong scalability, may adapt to different AI server platforms, allows for easy technical improvements, and has good promotion value.

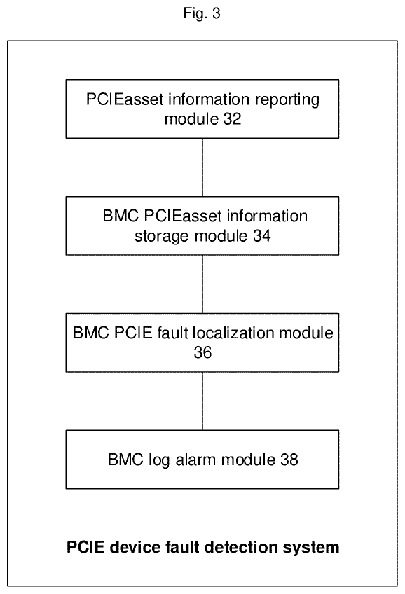

In some embodiments, the above method for determining a faulty device may be applied to a PCIE device fault detection system for determining a faulty device provided in the present disclosure. As shown in FIG. 3, the system is composed of a BIOS PCIE asset information reporting module 32, a BMC PCIE asset information storage module 34, a BMC PCIE fault localization module 36, and a BMC log alarm module 38.

The PCIE asset information reporting module 32 may traverse PCIE devices (Eps) during the BIOS Post (power-on), initialize and store an Ep linked list, identify PCIE devices directly connected to a motherboard and under a switch board, sequentially parse information for each valid PCIE device, acquire a BDF of the Ep, BDFs of upper four-level devices of the Ep, and a RootPort BDF where the Ep is located, acquire SlotId corresponding to RootPort, and acquire corresponding silkscreen information of the motherboard, RpSecBus, and RpSubBus according to SlotId and place same in the Ep linked list. During the traversal, whether a switch bridge is present in a link between an Rp and the Ep is further scanned, and a scan result (i.e., the above indication information) is further added to the Ep linked list. At the same time, it is determined whether a smart network card is connected according to DeviceId and VendorId of the Ep, and the reporting of a virtual network card device inside the network card is filtered out, so as to save the storage resources of a BMC and improve the capability of the BMC to accurately locate the fault of the smart network card. The module continues to traverse all bridges, initializes and stores a switch linked list, identifies the switch bridges on the switch board, sequentially parses information for each valid switch, acquires a corresponding BDF of the switch, SwitchSecBus, SwitchSubBus, and silkscreen information of the switch board, and adds same to the switch linked list. Finally, the Ep linked list and the switch linked list are placed into a shared memory, and the BMC PCIE asset information storage module is informed.

The asset information storage module 34 parses the linked list to obtain a PCIE asset information table and a PCIE switch asset information table. When the fault is actually transmitted, the system may trigger a System Management Interrupt (SMI) to send a BDF of an error reporting device and error register information to the BMC PCIE fault localization module 36.

The PCIE fault localization module 36 completes matching and searching in the PCIE asset information table and the PCIE switch asset information table according to a specific rule based on a BDF of a faulty device. in a case where the search is successful, a corresponding silkscreen is displayed, and in a case where the search is not successful, Not Found is displayed, and the BMC log alarm module 38 is called to generate an alarm log.

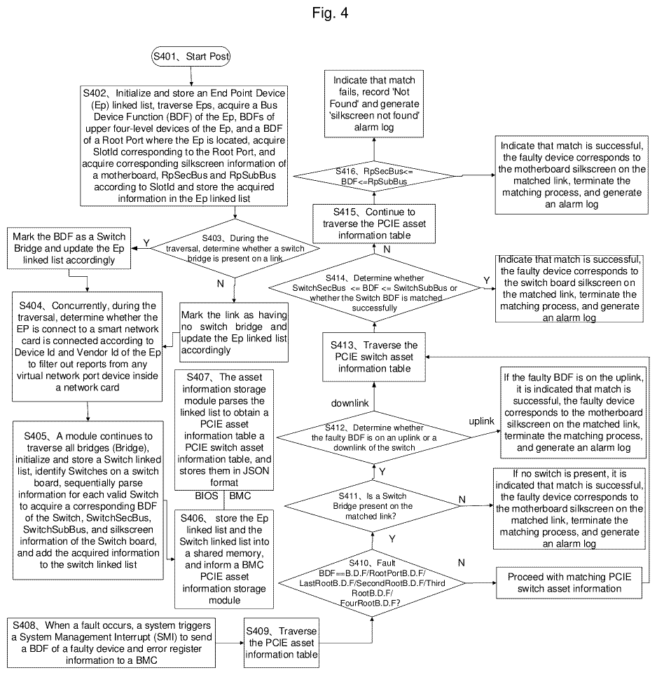

In one optional embodiment, the present disclosure further provides an optional method for determining a faulty PCIE device, an implementation process of which is shown in FIG. 4, and includes the following steps.

At S401, a machine is powered on and a BIOS is started.

At S402, a PCIE asset information reporting module starts traversal of PCIE devices (Eps), initializes and stores an Ep linked list, identifies PCIE devices directly connected to a motherboard and under a switch board, sequentially parses information for each valid PCIE device, acquires a BDF of the Ep, BDFs of upper four-level devices of the Ep, and a RootPort BDF where the Ep is located, acquires SlotId corresponding to RootPort, and acquires corresponding silkscreen information of the motherboard, RpSecBus, and RpSubBus according to SlotId and places same in the Ep linked list.

At S403, during the traversal, whether a switch bridge is present in a link between an Rp and the Ep is further scanned, and a scan result is added to the linked list, if yes, the BDF is marked as a switch bridge and updated to the Ep linked list, otherwise the link is marked as having no switch bridge and updated to the Ep linked list.

At S404, during the traversal, it is determined whether a smart network card is connected according to DeviceId and VendorId of the Ep, so as to filter out the reporting of a virtual network port device inside a network card.

At S405, the module continues to traverse all the bridges, initializes and stores a switch linked list, identifies the switches on the switch board, sequentially parses information for each valid switch, acquires a corresponding BDF of the switch, SwitchSecBus, SwitchSubBus, and silkscreen information of the switch board, and adds same to the switch linked list.

At S406, the Ep linked list and the switch linked list are placed into a shared memory, and a BMC PCIE asset information storage module is informed.

At S407, the asset information storage module parses the linked list to obtain a PCIE asset information table a PCIE switch asset information table, and stores same in JSON format.

At S408, when an actual fault occurs, a system triggers an SMI to send a BDF of the faulty device and error register information to a BMC PCIE fault localization module.

At S409, the PCIE asset information table is traversed.

At S410, it is determined whether a BDF to be queried matches the BDF of the Ep. The BDF of the Ep includes B.D.F/RootPort B.D.F/LastRoot B.D.F/SecondRoot B.D.F/ThirdRoot B.D.F/FourRoot B.D.F. When the BDF to be queried matches the BDF of the Ep, S411 is performed, otherwise S413 is performed.

At S411, it is confirmed whether the switch bridge is present in the matched link. If no switch is present, the matching is successful, the faulty device is a silkscreen of the motherboard on the matched link, and the matching process is terminated, otherwise S412 is performed.

At S412, it is confirmed whether the BDF of the faulty device is on an uplink or downlink of the switch. If the BDF is on the uplink, the matching is successful, the faulty device is the silkscreen of the motherboard on the matched link, and the matching process is terminated. If the BDF is on the downlink, S413 is performed.

At S413, a PCIE switch asset information table is traversed.

At S414, it is determined whether the BDF to be queried matches the BDF of the switch, and it is determined whether the BDF to be queried is located within the range of SwitchSecBus and SwitchSubBus. If the BDF to be queried matches the BDF of the switch, or is located within the range of SwitchSecBus and SwitchSubBus (SwitchSecBus<=BDF<=SwitchSubBus), it indicates that the matching is successful, the faulty device is a silkscreen of the switch board on the matched link, and the matching process is terminated. If the BDF to be queried does not match, S415 is performed.

At S415, the PCIE asset information table is traversed.

At S416, it is determined whether the BDF to be queried is located within the range of RpSecBus and RpSubBus. If the BDF to be queried is located within the range of RpSecBus and RpSubBus (RpSecBus<=BDF<=RpSubBus), it indicates that the matching is successful, the faulty device is the silkscreen of the motherboard on the matched link, and the matching process is terminated. If the BDF to be queried still does not match, NOT FOUND is displayed, and the matching process is terminated.

After the above steps are performed, a BMC log alarm module generates an alarm log according to the error register information and matching results (NOT FOUND/the silkscreen of the motherboard x/the silkscreen of the switch board), displays the alarm log on a web interface, and determines whether to inform the operation and maintenance personnel through email for repair according to the error level (correctable error/uncorrectable error) parsed from the error register information. Therefore, the position and error level of the faulty device can be accurately located, so that the fault can be repaired faster.

In one optional embodiment, the present disclosure provides an optional system architecture, as shown in FIG. 5, FIG. 5 describes a connection method between a plurality of devices such as a motherboard, a switch board, a bridge (namely, bridge device), a switch bridge (namely, switch bridge device), etc., in the present disclosure, so as to better understand the present disclosure.

A PCIE device includes Ep1, Ep2, and Ep3, where Ep1 and Ep2 are PCIE devices directly connected to the motherboard, Ep1 is connected to a smart network card, and Ep3 is a PCIE device connected to the switch board. For Ep1, since the smart network card is connected, when an Ep linked list is generated, BDF information reported by a virtual network port device on a device link is filtered out. Therefore, the Ep linked list corresponding to Ep1 stores a BDF of a root port RP1 corresponding to Ep1 and a BDF of Ep1. In an Ep linked list corresponding to Ep2, a BDF of RP2, BDFs of Bridge1 to Bridge3 (shown here for illustrative purposes, and fewer or more bridges may be present in actual applications), and a BDF of Ep2 are stored. An Ep linked list corresponding to Ep3 includes a BDF of RP3, the BDF of Bridge1, the BDF of Switch Bridge2, and a BDF of Ep3.

Through the above description of implementations, those skilled in the art may clearly know that the method according to the above embodiments may be implemented by means of software plus a necessary common hardware platform, certainly by means of hardware; but in many cases, the former is the better implementation. Based on such understanding, the technical solution of the present disclosure, which is essential or contributes to the related art, may be embodied in the form of a software product. The computer software product is stored in a non-volatile computer readable storage medium (such as a ROM/RAM, a magnetic disk and an optical disc), including a number of instructions for causing a terminal device (which may be a mobile phone, a computer, a server, or a network device, etc.) to perform the methods described in various embodiments of the present disclosure.

In the present embodiment, an apparatus for determining a faulty device is further provided. The apparatus is configured to implement the above embodiments and optional implementations. The embodiments and optional implementations that have been elaborated will not be repeated here. The term “module” used below can realize a combination of software and/or hardware with an intended function. Although the apparatus described in the following embodiment is preferably realized by software, but by hardware or a combination of software and hardware is also possible and conceived.

FIG. 6 is a structural block diagram of an apparatus for determining a faulty device according to an embodiment of the present disclosure. As shown in FIG. 6, the apparatus includes an acquisition module 62, a search module 64, a first determination module 66, and a second determination module 68.

The acquisition module 62 is configured to acquire a target device Identifier (ID) of a target faulty device.

The search module 64 is configured to search preset N+M pieces of link information for link information which comprises the target device ID, wherein the N+M pieces of link information have a one-to-one correspondence with N+M connection devices; the N+M connection devices comprise N connection devices on a motherboard and M connection devices on a switch board; each of the M connection devices is connected to one of P switches on the switch board; and the i-th piece of link information among the N+M pieces of link information comprises device IDs of a plurality of devices on the i-th device link which is formed from a processor on the motherboard to the i-th connection device, wherein N, M, and P all are positive integers, and i and j are positive integers less than or equal to N+M.

The first determination module 66 is configured to, in a case where the j-th piece of link information which comprises the target device ID is found from the N+M pieces of link information and the j-th piece of indication information in the j-th piece of link information indicates that a first switch is present on the j-th device link which is formed from the processor to the j-th connection device, determine whether the target faulty device on the j-th device link is located between the processor and the first switch, wherein the first switch is one of the P switches.

The second determination module 68 is configured to, in a case where the target faulty device is not located between the processor and the first switch, determine whether the target faulty device is a device on the switch board based on preset record item information and the target device ID, wherein the record item information comprises a device ID of each of the P switches.

Through the above apparatus, the N+M pieces of preset link information is searched for the link information which includes the target device ID of the target faulty device, where each piece of link information corresponds to one connection device; the connection devices include the N connection devices on the motherboard and the M connection devices on the switch board; each of the M connection devices is connected to one of the P switches on the switch board; and the link information includes the device IDs of the plurality of devices on the device link which is formed from the processor on the motherboard to the connection device; in a case where the j-th piece of link information which includes the target device ID is found and the indication information included in the link information indicates that the first switch is present on the device link, it is determined whether the target faulty device on the device link is located between the processor and the first switch; and in a case where the target faulty device is not located between the processor and the first switch, it is determined whether the target faulty device is a device on the switch board based on the preset record item information and the target device ID, where the record item information includes the device ID of each of the switches. By adopting the above solution, the position of the faulty device can be accurately located, so that the faulty device can be repaired as soon as possible, the time spent on troubleshooting can be reduced, and the user experience can be improved, thereby solving the technical problem in the related art that accurately determining a faulty device for ordinary PCIE devices can be achieved, but determining a faulty device for AI models with switch boards is insufficiently accurate.

In some embodiments, the above search module 64 is further configured to, in a case where the j-th piece of link information which includes the target device ID is found from the N+M pieces of link information, and the j-th piece of indication information indicates that the j-th device link does not include the first switch, determine that the target faulty device is a device on the motherboard.

In some embodiments, in a case where the link information which includes the target device ID is matched among the N+M pieces of preset link information, and it is determined that no switch bridge (i.e., the first switch) is present in the device link corresponding to the link information according to the indication information included in the link information, it is determined that the target faulty device is a device on the motherboard.

Through the present embodiment, after the link where the target device ID is located is matched, it is further confirmed whether the switch bridge is present on the link, so as to avoid misjudgment and improve the accuracy of localization of the faulty device.

In some embodiments, the above first determination module 66 is further configured to, in a case where the target faulty device is located between the processor and the first switch, determine that the target faulty device is a device on the motherboard.
in a case where it is determined that the target faulty device is between the processor and the first switch, it is determined that the faulty device is on an uplink of the switch bridge, then it is determined that the faulty device is a device on the motherboard, and the matching process is terminated.

In some embodiments, the above first determination module 66 is further configured to, in a case where, within the j-th piece of link information, the target device ID is located between a device ID of the processor and the device ID of the first switch, determine that the target faulty device on the j-th device link is located between the processor and the first switch.

Each piece of link information contains the device IDs of the plurality of devices between the processor to the connection device, and the storage order of the device IDs is configured to represent the order of different devices in the link. Therefore, it is determined whether the target faulty device is located on the uplink of the switch bridge by determining whether the target device ID is located between the device ID of the processor and the device ID of the first switch.

Through the present embodiment, after it is determined that the switch bridge is present in the link, it is further determined whether the faulty device is a device on the motherboard by determining whether the faulty device is located on the uplink of the switch bridge, thereby accurately locating the position of the faulty device.

In some embodiments, the above second determination module 68 is further configured to search the record item information for a record item which includes the target device ID, where the record item information includes P record items, the k-th record item among the P record items includes the device ID of the k-th switch among the P switches, where k is a positive integer less than or equal to P; and in a case where the p-th record item which includes the target device ID is found within the record item information, determine that the target faulty device is a device on the switch board and the target faulty device is one of the P switches, where p is a positive integer less than or equal to P, and the device ID of the p-th switch among the P switches included in the p-th record item is equal to the target device ID.

The process of determining whether the target faulty device is a device on the switch board includes: searching the record item information (a PCIE switch asset information table corresponding to a switch linked list) for the record item which includes the target device ID, where each record item in the record item information contains the device ID of the switch (switch bridge); and in a case where the record item which contains the ID of the target device is found, it is determined that the target faulty device is a device on the switch board, and the category of the target faulty device is a switch bridge.

According to the present embodiment, on the basis of matching the faulty link, a BDF (device ID) of the switch bridge is further matched in the PCIE switch asset information table, thereby accurately locating the position of the target faulty device.

In some embodiments, the above second determination module 68 is further configured to determine P bus number ranges based on P SecBus numbers and P SubBus numbers corresponding to the P switches included in the record item information, where the record item information includes the P record items, and the k-th record item among the P record items includes the device ID of the k-th switch among the P switches and the SecBus number and the SubBus number of the k-th switch, where k is a positive integer less than or equal to P, a minimum value of the k-th bus number range among the P bus number ranges is the SecBus number of the k-th switch, and a maximum value of the k-th bus number range is the SubBus number of the k-th switch; determine whether the target device ID is located within the P bus number ranges; and in a case where it is determined that the target device ID is located within one of the P bus number ranges, determine that the target faulty device is a connection device among the M connection devices on the switch board.

Each record item in the record item information further includes the SecBus number (SwitchSecBus) and the SubBus number (SwitchSubBus) corresponding to the switch, thereby determining the P bus number ranges corresponding to the P switches, where the bus number range is [SwitchSecBus, SwitchSubBus]. It is determined whether the target device ID is located within any one of the P bus ranges, that is, (SwitchSecBus<=BDF<=SwitchSubBus), and in a case where the matching is successful (namely, it is determined that the target device ID is located within one of the P bus number ranges), it is determined that the target faulty device is one of the M connection devices on the switch board.

In some embodiments, the above second determination module 68 is further configured to, in a case where it is determined that the target device ID is not located within any one of the P bus number ranges, determine N+M bus number ranges based on N+M SecBus numbers and N+M SubBus numbers corresponding to the N+M connection devices included in the N+M pieces of link information, where the i-th piece of link information among the N+M pieces of link information further includes a SecBus number and a SubBus number of a root port where the i-th connection device is located, where a minimum value of the i-th bus number range among the N+M bus number ranges is the SecBus number of the root port where the i-th connection device is located, and a maximum value of the i-th bus number range is the SubBus number of the root port where the i-th connection device is located; determine whether the target device ID is located within the N+M bus number ranges; and in a case where it is determined that the target device ID is located within one of the N+M bus number ranges, determine that the target faulty device is a device on the motherboard.
in a case where the target device ID is not located within any one of the P bus number ranges, it is necessary to continue to traverse the PCIE asset information table which includes the N+M pieces of link information. The link information further includes the SecBus number (i.e., RpSecBus) and the SubBus number (i.e., RpSubBus) of the root port (Rootport) where the connection device is located. The N+M bus number ranges ([RpSecBus, RpSubBus]) are determined, and then it is determined whether the target device ID is located within any one of the N+M bus number ranges. in a case where the matching is successful (that is, RpSecBus<=BDF<=RpSubBus) (namely, it is determined that the target device ID is located within one of the N+M bus number ranges), it is determined that the target faulty device is a device on the motherboard.

In some embodiments, the above second determination module 68 is further configured to, in a case where it is determined that the target device ID is not located within any one of the N+M bus number ranges, display first prompt information, where the first prompt information is configured to indicate that the position of the target faulty device is undetermined.

After the above matching process, in a case where it is determined that the target device ID is not located within any one of the N+M bus number ranges, it indicates that the matching fails, and at this time, the first prompt information is displayed to a user to inform the user that the position of the target faulty device cannot be determined, and the matching process is terminated.

In some embodiments, the above search module 64 is further configured to, in a case where link information which includes the target device ID is not found within the N+M pieces of link information, determine whether the target faulty device is a device on the switch board based on the preset record item information and the target device ID.
in a case where a BDF (target device ID) to be queried does not match the link information which includes the target device ID in the PCIE asset information table, that is, the BDF to be queried does not match a BDF of an Ep, BDFs of upper four-level devices of the Ep, and a RootPort BDF where the Ep is located, and the matching of the PCIE switch asset information (i.e., the above preset record item information) is also continued. The PCIE asset information table is configured to store the above N+M pieces of preset link information.

In some embodiments, the above first determination module 66 is further configured to, in a case where, within the j-th piece of link information, the target device ID is not located between the device ID of the processor and the device ID of the first switch, determine that the target faulty device on the j-th device link is not located between the processor and the first switch.
in a case where it is determined in the j-th piece of link information that the position of the target device ID is not between the device ID of the processor and the device ID of the first switch, it is determined that the target faulty device is not located between the processor and the first switch, that is, the faulty device is not on the uplink of the switch bridge.

In some embodiments, the above second determination module 68 is further configured to acquire an ID of the switch board and display second prompt information, where the second prompt information includes the ID of the switch board, and the second prompt information is configured to indicate that the target faulty device is a device on the switch board; or acquire an ID of the switch board and display third prompt information in a case where the target faulty device is one of the M connection devices, where the third prompt information includes the ID of the switch board, and the third prompt information is configured to indicate that the target faulty device is one of the M connection devices on the switch board; or acquire an ID of the switch board and display fourth prompt information in a case where the target faulty device is one of the P switches, where the fourth prompt information includes the ID of the switch board, and the fourth prompt information is configured to indicate that the target faulty device is one of the P switches on the switch board.

After it is determined that the target faulty device is a device on the switch board, different prompt information is displayed to the user according to the category of the target faulty device, where the category of the target faulty device located on the switch board includes: one (i.e., the PCIE device) of the M connection devices on the switch board, one (i.e., the switch bridge) of the P switches, and other devices on the link. in a case where it is determined that the category of the target faulty device is another device on the link, the ID of the switch board (i.e., silkscreen information of the switch board) is displayed to the user, and the user is informed that the target faulty device is another device on the link. in a case where it is determined that the category of the target faulty device is one of the M connection devices on the switch board, the ID of the switch board is displayed to the user, and the user is informed that the target faulty device is one of the M connection devices. in a case where it is determined that the category of the target faulty device is one of the P switches, the ID of the switch board is displayed to the user, and the user is informed that the category of the target faulty device is one of the P switch boards.

In one optional embodiment, after the target faulty device is located as a device on the switch board and the silkscreen information of the switch board and the category information of the target faulty device are displayed to the user, the target faulty device may further be displayed to the user, that is, the BDF information of the target faulty device is directly displayed to the user, and/or the device ID information of the target faulty device is matched according to the BDF information and displayed to the user, as shown in FIG. 5, to help the user to confirm the target faulty device on the switch board.

Through the present embodiment, while determining the silkscreen information of the switch board, the category of the faulty device is clarified, so that the user can accurately determine the repair strategy and locate the faulty device according to the information, thereby improving the user experience.

In some embodiments, the above acquisition module 62 is further configured to acquire the ID of the switch board from the record item information, where the record item information includes the ID of the switch board and the P record items, and the k-th record item among the P record items includes a device ID of the k-th switch of the P switches.

The ID of the switch (i.e., the silkscreen information of the switch board) may be queried in the record item information. The record item information is the PCIE switch asset information generated based on the switch linked list, in which the BDF of each switch bridge and the silkscreen information of the switch board are stored.

In some embodiments, the above second determination module 68 is further configured to acquire an ID of the motherboard and display fifth prompt information, where the fifth prompt information includes the ID of the motherboard, and the fifth prompt information is configured to indicate that the target faulty device is a device on the motherboard; or acquire an ID of the motherboard and display sixth prompt information in a case where the target faulty device is one of the N connection devices, where the sixth prompt information includes the ID of the motherboard, and the sixth prompt information is configured to indicate that the target faulty device is one of the N connection devices on the motherboard; or acquire an ID of the motherboard and display seventh prompt information in a case where the target faulty device is a device other than the N connection devices on the motherboard, where the seventh prompt information includes the ID of the motherboard, and the seventh prompt information is configured to indicate that the target faulty device is a device other than the N connection devices on the motherboard.
in a case where it is determined that the target faulty device is a device on the motherboard, it is necessary to acquire the silkscreen information of the corresponding motherboard (i.e., the ID of the above motherboard), and display different prompt information to the user according to the category of the target faulty device, where the categories of the target faulty device located on the motherboard include: one of the N connection devices on the motherboard, a device on the motherboard, and a device other than the N connection devices on the motherboard. in a case where the category of the target faulty device is a device on the motherboard, the silkscreen information of the motherboard is displayed to the user, and the user is informed that the target faulty device is the device on the motherboard. Alternatively, in a case where it is determined that the target faulty device is one of the N connection devices, the screen information of the motherboard is displayed to the user, and the user is informed that the target faulty device is one of the N connection devices. Alternatively, in a case where it is determined that the target faulty device is a device other than the N connection devices on the motherboard, the silkscreen information of the motherboard is displayed to the user, and the user is informed that the target faulty device is a device other than the N connection devices on the motherboard.

In one optional embodiment, after the target faulty device is located as a device on the motherboard and the silkscreen information of the motherboard and the category information of the target faulty device are displayed to the user, the target faulty device may further be displayed to the user, that is, the BDF information of the target faulty device is directly displayed to the user, and/or the device ID information of the target faulty device is matched according to the BDF information and displayed to the user, as shown in FIG. 5, to help the user to confirm the target faulty device on the motherboard according to the BDF information, for example, EP1 and Bridge3 etc.

Through the present embodiment, on the basis of determining that the target faulty device is a device on the motherboard, the category of the target faulty device is further determined, thereby helping the user to more accurately perform fault repair according to the category and position of the faulty device.

In some embodiments, the above acquisition module 62 is further configured to acquire the ID of the motherboard from predetermined connection device description information, where the connection device description information includes the ID of the motherboard and the N+M pieces of link information.

The silkscreen information of the motherboard may be found from the predetermined connection device description information, i.e., the PCIE asset information table, in which the ID of the motherboard (i.e., the silkscreen information of the motherboard) and the N+M pieces of link information are stored.

In some embodiments, the above search module 64 is further configured to acquire device IDs of a plurality of devices on each of N+M device links, where the N+M device links include a device link which is formed from the processor to each of the N+M connection devices, and the device IDs of the plurality of devices on the i-th device link among the N+M device links include a device ID of the i-th connection device and a device ID of the root port where the i-th connection device is located; acquire the ID of the motherboard; and acquire a SecBus number and a SubBus number of a respective root port where each of the N+M connection devices is located.

Before starting fault detection, an Ep linked list (i.e., the above connection device description information) needs to be constructed. The Ep linked list contains the device IDs of the plurality of devices on each of the N+M device links, and each device link contains the plurality of devices between the processor and the connection device, including the connection device and the upper four-level devices of the connection device. In addition, the BDF of RootPort where the connection devices are located and the silkscreen information of the motherboard need to be acquired, and RpSecBus (SecBus number) and RpSubBus (SubBus number) of the root port where each connection device is located are acquired.

In some embodiments, the above search module 64 is further configured to determine whether one of the P switches is present on each of the N+M device links to obtain N+M pieces of indication information, where the i-th indication information among the N+M pieces of indication information is configured to indicate whether one of the P switches is present on the i-th device link.

During the traversal and generation of the Ep linked list, whether the switch bridge (i.e., the switch) is present in the link between the Rp (root port) and the Ep is further scanned, and a scan result (indication information) is further added to the Ep linked list. The indication information is configured to indicate whether a switch is present on the device link.

In some embodiments, the above acquisition module 62 is further configured to, in a case where N+M connection devices are not virtual network port devices, acquire the device IDs of the plurality of devices on each of the N+M device links sent by the N+M connection devices.

During the traversal, it is determined whether the connection device is connected to the smart network card according to DeviceId and VendorId of the connection device. in a case where the smart network card is connected, the reporting of the virtual network port device inside the network card may be filtered out, that is, in a case where the connection device is not a virtual network port device, the device IDs of the plurality of devices on the corresponding device link may be acquired.

Through the present embodiment, by filtering out the reporting of the virtual network card device, the storage resources of the BMC may be saved and the capability of the BMC to accurately locate the fault of the smart network card may be improved.

In some embodiments, the above second determination module 68 is further configured to acquire the device ID of each of the P switches; acquire the ID of the switch board; and acquire the SecBus number and the SubBus number of each of the P switches.

The module continues to traverse all bridges, identifies the switch bridges on the switch board, sequentially parses information for each valid switch bridge, and acquires the corresponding BDF of the switch (device ID of the switch), SwitchSecBus (SecBus number), SwitchSubBus (SubBus number), and the silkscreen information of the switch board (ID of the switch board).

In some embodiments, the above second determination module 68 is further configured to record the device ID of each of the P switches and the SecBus number and the SubBus number of each of the P switches into the P record items in the record item information, where the k-th record item among the P record items includes the device ID of the k-th switch among the P switches and the SecBus number and the SubBus number of the k-th switch, where k is a positive integer less than or equal to P.

After the above information is acquired, the switch linked list, i.e., the above record item information, may be generated according to the above information, and the record item information includes the device ID of each of the P switches and the SecBus number and the SubBus number of each switch.

The present disclosure, through the collaborative coding of the BIOS and the BMC, covers determining faulty PCIE devices of the AI models with the switch boards and fault detection for the plurality of virtual network ports on the smart network cards, so as to reduce the storage space required by the BMC for the PCIE asset information table, improve the search efficiency, improve the operation and maintenance efficiency of AI data centers, and avoid errors caused by manually collecting related error information when automatic fault localization fails, thereby providing significant convenience for operation and maintenance, i.e., achieving a highly significant effect in application scenarios requiring accurate fault diagnosis and localization. At the same time, a code has strong scalability, may adapt to different AI server platforms, allows for easy technical improvements, and has good promotion value.

It is to be noted that, each of the above modules may be realized by software or hardware. For the latter, the each of the above modules may be realized by, but is not limited to, the following way: all of the above modules are in the same processor; or, the above modules are respectively in different processors in form of any combination.

The embodiments of the present disclosure further provide a computer non-volatile computer readable storage medium, in which a computer program is stored. The computer program is configured to perform the steps in any one of the above method embodiments when executed.

In one exemplary embodiment, the computer non-volatile computer readable storage medium may include, but is not limited to, a U disk, an ROM, an RAM, a mobile hard disk, a magnetic disk, a compact disc, and other non-volatile readable storage media capable of storing the computer program.

The embodiments of the present disclosure further provide an electronic device, which includes a memory and a processor. A computer program is stored in the memory, and the processor is configured to execute the computer program to perform the steps in any one of the above method embodiments.

In one exemplary embodiment, the electronic device may further include a transmission device and an I/O device. The transmission device is connected with the above processor, and the I/O device is connected to the above processor.

The examples in the present embodiment may refer to the above embodiments and the examples described in the optional implementations, which will not be elaborated herein.

It is apparent that those skilled in the art should appreciate that the above modules and steps of the present disclosure may be implemented by a general-purpose computing apparatus, and they may be centralized in a single computing apparatus or distributed on a network composed of multiple computing apparatuses; they may be implemented by a program code which is capable of being executed by the computing apparatus, so that they may be stored in a storage apparatus and performed by the computing apparatus; and in some situations, the presented or described steps may be performed in an order different from that described here; or they are made into integrated circuit modules, respectively; or multiple modules and steps of them are made into a single integrated circuit module to realize. In this way, the present disclosure is not limited to any particular combination of hardware and software.

The above are only the optional embodiments of the present disclosure, and are not intended to limit the present disclosure, and for those of ordinary skill in the art, various modifications and changes may be made to the present disclosure. Any modifications, equivalent substitutions, improvements, etc. within the principle of the present disclosure shall be included in the scope of protection of the present disclosure.

1. A method for determining a faulty device, comprising:
acquiring a target device Identifier (ID) of a target faulty device;
searching preset N+M pieces of link information for link information which comprises the target device ID, wherein the N+M pieces of link information have a one-to-one correspondence with N+M connection devices; the N+M connection devices comprise N connection devices on a motherboard and M connection devices on a switch board; each of the M connection devices is connected to one of P switches on the switch board; and the i-th piece of link information among the N+M pieces of link information comprises device IDs of a plurality of devices on the i-th device link which is formed from a processor on the motherboard to the i-th connection device of the N+M connection devices, wherein N, M, and P all are positive integers, and i and j are positive integers less than or equal to N+M;
in a case where the j-th piece of link information which comprises the target device ID is found from the N+M pieces of link information and the j-th piece of indication information in the j-th piece of link information indicates that a first switch is present on the j-th device link which is formed from the processor to the j-th connection device, determining whether the target faulty device on the j-th device link is located between the processor and the first switch, wherein the first switch is one of the P switches; and
in a case where the target faulty device is not located between the processor and the first switch, determining whether the target faulty device is a device on the switch board based on preset record item information and the target device ID, wherein the record item information comprises a device ID of each of the P switches.

2. The method according to claim 1, wherein after the searching preset N+M pieces of link information for link information which comprises the target device ID, the method further comprises:
in a case where the j-th piece of link information which comprises the target device ID is found from the N+M pieces of link information, and the j-th piece of indication information indicates that the first switch is not present on the j-th device link, determining that the target faulty device is a device on the motherboard.

3. The method according to claim 1, wherein after the determining whether the target faulty device on the j-th device link is located between the processor and the first switch, the method further comprises:
in a case where the target faulty device is located between the processor and the first switch, determining that the target faulty device is a device on the motherboard.

4. The method according to claim 1, wherein the determining whether the target faulty device on the j-th device link is located between the processor and the first switch comprises:
in a case where, within the j-th piece of link information, the target device ID is located between a device ID of the processor and the device ID of the first switch, determining that the target faulty device on the j-th device link is located between the processor and the first switch.

5. The method according to claim 1, wherein the determining whether the target faulty device is a device on the switch board based on preset record item information and the target device ID comprises:
searching the record item information for a record item which comprises the target device ID, wherein the record item information comprises P record items, the k-th record item among the P record items comprises the device ID of the k-th switch among the P switches, and k is a positive integer less than or equal to P; and
in a case where the p-th record item which comprises the target device ID is found within the record item information, determining that the target faulty device is a device on the switch board and the target faulty device is one of the P switches, wherein p is a positive integer less than or equal to P, and the device ID of the p-th switch among the P switches comprised in the p-th record item is equal to the target device ID.

6. The method according to claim 1, wherein the determining whether the target faulty device is a device on the switch board based on preset record item information and the target device ID comprises:
determining P bus number ranges based on P Secondary Bus (SecBus) numbers and P Subordinate Bus (SubBus) numbers corresponding to the P switches comprised in the record item information, wherein the record item information comprises P record items, and the k-th record item among the P record items comprises a device ID of the k-th switch among the P switches and a SecBus number and a SubBus number of the k-th switch, k is a positive integer less than or equal to P, a minimum value of the k-th bus number range among the P bus number ranges is the SecBus number of the k-th switch, and a maximum value of the k-th bus number range is the SubBus number of the k-th switch;
determining whether the target device ID is located within the P bus number ranges; and
in a case where it is determined that the target device ID is located within one of the P bus number ranges, determining that the target faulty device is one of the M connection devices on the switch board.

7. The method according to claim 6, wherein after the determining whether the target device ID is located within the P bus number ranges, the method further comprises:
in a case where it is determined that the target device ID is not located within any one of the P bus number ranges, determining N+M bus number ranges based on N+M SecBus numbers and N+M SubBus numbers corresponding to the N+M connection devices comprised in the N+M pieces of link information, wherein the i-th piece of link information among the N+M pieces of link information further comprises a SecBus number and a SubBus number of a root port where the i-th connection device is located, a minimum value of the i-th bus number range among the N+M bus number ranges is the SecBus number of the root port where the i-th connection device is located, and a maximum value of the i-th bus number range is the SubBus number of the root port where the i-th connection device is located;
determining whether the target device ID is located within the N+M bus number ranges; and
in a case where it is determined that the target device ID is located within one of the N+M bus number ranges, determining that the target faulty device is a device on the motherboard.

8. The method according to claim 7, wherein after the determining whether the target device ID is located within the N+M bus number ranges, the method further comprises:
in a case where it is determined that the target device ID is not located within any one of the N+M bus number ranges, displaying first prompt information, wherein the first prompt information is configured to indicate that a position of the target faulty device is undetermined.

9. The method according to claim 1, wherein after the searching preset N+M pieces of link information for link information which comprises the target device ID, the method further comprises:
in a case where the link information which comprises the target device ID is not found within the N+M pieces of link information, determining whether the target faulty device is a device on the switch board based on the preset record item information and the target device ID.

10. The method according to claim 1, wherein the determining whether the target faulty device on the j-th device link is located between the processor and the first switch comprises:
in a case where, within the j-th piece of link information, the target device ID is not located between a device ID of the processor and the device ID of the first switch, determining that the target faulty device on the j-th device link is not located between the processor and the first switch.

11. The method according to claim 1, wherein in a case where it is determined that the target faulty device is a device on the switch board, the method further comprises:
acquiring an ID of the switch board and displaying second prompt information, wherein the second prompt information comprises the ID of the switch board, and the second prompt information is configured to indicate that the target faulty device is a device on the switch board; or
acquiring an ID of the switch board, and displaying third prompt information in a case where the target faulty device is one of the M connection devices, wherein the third prompt information comprises the ID of the switch board, and the third prompt information is configured to indicate that the target faulty device is one of the M connection devices on the switch board; or
acquiring an ID of the switch board, and displaying fourth prompt information in a case where the target faulty device is one of the P switches, wherein the fourth prompt information comprises the ID of the switch board, and the fourth prompt information is configured to indicate that the target faulty device is one of the P switches on the switch board.

12. The method according to claim 11, wherein the acquiring an ID of the switch board comprises:
acquiring the ID of the switch board from the record item information, wherein the record item information comprises the ID of the switch board and P record items, and the k-th record item among the P record items comprises a device ID of the k-th switch of the P switches.

13. The method according to claim 2, wherein in a case where it is determined that the target faulty device is the device on the motherboard, the method further comprises:
acquiring an ID of the motherboard and displaying fifth prompt information, wherein the fifth prompt information comprises the ID of the motherboard, and the fifth prompt information is configured to indicate that the target faulty device is a device on the motherboard; or
acquiring an ID of the motherboard, and displaying sixth prompt information in a case where the target faulty device is one of the N connection devices, wherein the sixth prompt information comprises the ID of the motherboard, and the sixth prompt information is configured to indicate that the target faulty device is one of the N connection devices on the motherboard; or
acquiring an ID of the motherboard, and displaying seventh prompt information in a case where the target faulty device is a device other than the N connection devices on the motherboard, wherein the seventh prompt information comprises the ID of the motherboard, and the seventh prompt information is configured to indicate that the target faulty device is a device other than the N connection devices on the motherboard.

14. The method according to claim 13, wherein the acquiring an ID of the motherboard comprises:
acquiring the ID of the motherboard from predetermined connection device description information, wherein the connection device description information comprises the ID of the motherboard and the N+M pieces of link information.

15. The method according to claim 1, wherein before the searching preset N+M pieces of link information for link information which comprises the target device ID, the method further comprises:
acquiring device IDs of a plurality of devices on each of N+M device links, wherein the N+M device links comprise device links respectively formed from the processor to each of the N+M connection devices, and the device IDs of the plurality of devices on the i-th device link among the N+M device links comprise a device ID of the i-th connection device and a device ID of a root port where the i-th connection device is located;
acquiring an ID of the motherboard; and
acquiring a SecBus number and a SubBus number of a respective root port where each of the N+M connection devices is located.

16. The method according to claim 15, wherein before the searching preset N+M pieces of link information for link information which comprises the target device ID, the method further comprises:
determining whether one of the P switches is present on each of the N+M device links, to obtain N+M pieces of indication information, wherein the i-th indication information among the N+M pieces of indication information is configured to indicate whether one of the P switches is present on the i-th device link.

17. The method according to claim 15, wherein the acquiring device IDs of a plurality of devices on each of N+M device links comprises:
in a case where the N+M connection devices are not virtual network port devices, acquiring the device IDs of the plurality of devices on each of the N+M device links sent by the N+M connection devices.

18. The method according to claim 1, wherein before the determining whether the target faulty device is a device on the switch board based on preset record item information and the target device ID, the method further comprises:
acquiring a device ID of each of the P switches;
acquiring an ID of the switch board; and
acquiring a SecBus number and a SubBus number of each of the P switches.

19. The method according to claim 18, wherein before the determining whether the target faulty device is a device on the switch board based on preset record item information and the target device ID, the method further comprises:
recording the device ID of each of the P switches, and the SecBus number and the SubBus number of each of the P switches into the P record items in the record item information, wherein the k-th record item of the P record items comprises the device ID of the k-th switch among the P switches, and the SecBus number and the SubBus number of the k-th switch, k is a positive integer less than or equal to P.

20. (canceled)

21. (canceled)

22. An electronic device, comprising a memory, a processor, and a computer program stored in the memory and executable on the processor, wherein the processor is configured to implement steps of the method according to claim 1 when executing the computer program.
